(19) United States
(12) Patent Application Publication
(10) Pub. No.: US 2004/0030922 A1
(43) Pub. Date: Feb. 12, 2004

(54) Client-application acquisition of network-entity SNMP community string passwords

(76) Inventor: Scott Craig Koss, Vancouver, WA (US)

Correspondence Address: David C. Ripma, Patent Counsel, Sharp Laboratories of America, Inc., 5750 NW pacific Rim Boulevard, Camas, WA, 98607, US

(21) Appl. No.: 10/213,846

(22) Filed: Aug. 7, 2002

(51) Int. Cl. H04L 9/00

(52) U.S. Cl. 713/201

(57) ABSTRACT

A network system and methodology wherein a site is provided on a network for containing the SNMP community data strings of various network entities, such as MFP devices. Client applications seeking use of one or more of these entities are self-equipped to issue an authentication identifying themselves, after which they receive, from the appropriate site, relevant SNMP community data-string information.

### BACKGROUND AND SUMMARY OF THE INVENTION

This invention relates to network communications between a client application and a network entity, such as a multi-function printer (MFP) device, which are each connected for use on a network. In particular, it pertains to a method and apparatus which enables a client application to obtain SNMP community string password data which guards use-access to a network entity like the kind just mentioned. In this context, the invention also relates to the provision of a unique self-authentication client application structure which is enabled to seek access to SNMP-guarded network entities through acquiring the appropriate SNMP community strings.

As the use of computers and associated peripheral devices continues to grow, for various reasons, it has become increasingly important to guard use-access to certain network entities through what are known as SMNP data string passwords, or strings. These strings must be employed in order for a client application to employ such an entity. As the use of such network installations grows, it has become increasingly important to find efficient and effective ways to enable appropriate use communications to take place between a client application and various network entities, without unnecessarily requiring constant intervention and attention by, for example, a network manager of information services. In particular, it would be very useful to furnish a method and structure in computer communication network characterized by an appropriate “self capability” in certain client applications, to be able efficiently to gain appropriate knowledge of particular SNMP entity community strings. Such a condition would greatly aid the process of communication between such an application and a protected network SNMP entity.

The present invention takes direct aim at this desirable state of affairs by offering a unique and very effective automated system and methodology, whereby selected client applications are permitted, through self-furnishing appropriate “on-board” authorization information specifically relating to them, to acquire SNMP community strings that are associated with particular network entities. Several different very effective and useful approaches toward implementing this system and method invention are shown and described herein. One such approach involves a network-connected database server which is equipped to contain all relevant SNMP network-entity SNMP passwords, and to act as an appropriate deliverer of those passwords to authorized, inquiring client applications. Another useful approach involves an arrangement whereby a client application is permitted to inquire, after proper authorization communication, directly of the sought “end-use” network entity to gather from it per se that entity's specific, SNMP community string.

The proposed method and system of this invention thus feature, among other things, uniquely configured client applications which are armed to take a “leading role” in gathering appropriate SNMP password information at times when they need to communicate with related, guarded network entities, such as the MPF-type device mentioned earlier herein.

Various other features and advantages that are offered by the methodology and system of this invention will become more fully apparent as the description which now follows is read in conjunction with the accompanying drawings.

### DESCRIPTION OF THE DRAWINGS

FIG. 1 is a simplified and fragmentary block/schematic diagram illustrating a system and a methodology, each in preferred forms, and constructed in accordance with the present invention. Specifically this diagram illustrates such a system and a methodology wherein an appropriate SNMP community string database server is included in the network, which server gathers and makes available, in accordance with the invention, specific SNMP passwords that are associated with various network resources (entities), such as MFP devices.

FIG. 2 is a fragmentary, block/schematic view illustrating a modified form of the system and methodology of the present invention, and specifically one wherein the same kind of database server which is present in the network of FIG. 1 is also employed, but here under circumstances where, rather than it gathering SNMP information relating to network resources, the latter report their respective SNMP passwords to the database server.

FIG. 3 is a block/schematic diagram generally illustrating a preferred pattern of authorization and SNMP password acquisition which occurs in the practice of the methodology of the present invention.

FIG. 4 is a fragmentary, block/schematic diagram illustrating yet another modified form of the invention wherein client applications seeking to use network entities, and network entities which are so sought, directly communicate with one another, with the former issuing authentication data, and the latter returning, to specific, requesting, authenticated client applications, their respective, associated, SNMP community-string passwords.

### DETAILED DESCRIPTION OF THE INVENTION

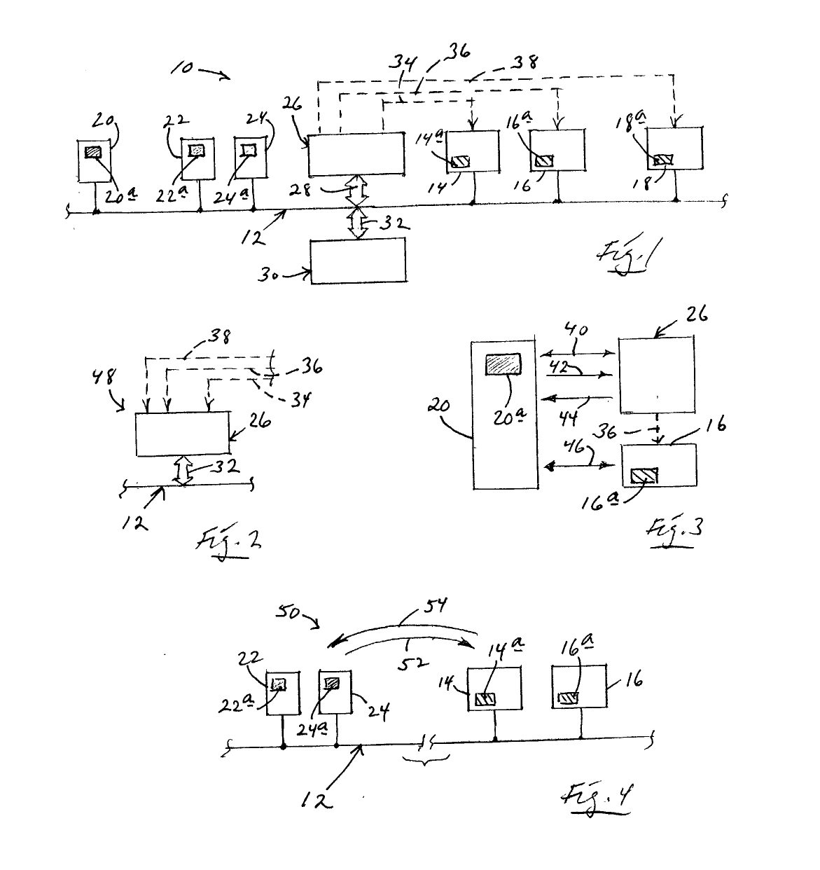

Turning now to the drawings, and referring first of all to FIG. 1, here, there is indicated generally at 10 a computer network system which is constructed, and which operates, in accordance with a preferred embodiment, and manner of practicing, respectively, the present invention. Included within network 10 is a data-communication structure 12 which may either be hard-wired or non-hard-wired, plural MFP devices, also referred to herein as guarded network entities, 14, 16, 18, and client applications 20, 22, 24, each of which may wish to gain use access to any one or all three of the illustrated MFP devices. Each of these client applications has a structure with unique features introduced by th present invention. These special features relate to the process of authentication which is key to a related client application's ability to acquire the SNMP community string associated with a network device which the application “wishes” to use.

In network 10, each one of MFP devices 14, 16, 18 is guarded, with respect to client-application access, by an appropriate and conventional SNMP community-string password, also referred to herein as a string. The respective strings for devices 14, 16, 18 are represented, respectively, by shaded rectangles at 14a, 16a, 18a.

Also included in network 10, and illustrated by a block shown at 26, is a community string database server which operates in accordance with the present invention. This server is shown connected to data-communication structure 12 through a data path 28. Server 26 is also referred to herein as a residence site for SNMP strings. Pictured immediately below server 26 in FIG. 1 is an information-manager computer station 30 which is communicatively connected to data-communication structure 12 via a data path shown at 32.

In accordance with the structure and methodology of the present invention, each of the three illustrated client applications, 20, 22, 24, is equipped with what is referred to herein as a self-capability for authenticating itself to server 26 for the purpose, as will shortly be more fully explained, of gaining use knowledge of any one or more of the community strings, 14a, 16a, 18a, associated, respectively, with MFP devices 14, 16, 18. These “self-capabilities” of client-applications 20, 22, 24, which are special client-application features provided by the present invention, are represented respectively by shaded blocks 20a, 22a, 24a, respectively.

Finally illustrated in FIG. 1, by dashed lines 34, 36, 38, are certain communications which will be more fully described that take place in system 10 between server 26 and MFP devices 14, 16, 18, respectively. One will note that single arrow heads are presented with these dashed lines, which arrow heads are on the ends of the respective lines that lead to the three MFP devices.

Describing now generally how the system and method illustrated in FIG. 1 operate, and focussing attention now on FIGS. 1 and 3 together. The various steps of activity now to be described are presented graphically in FIG. 3. Accordingly, and for the purpose of illustration now, activity in FIG. 3 is illustrated in a relationship between MFP device 16, client application 20, and server 26.

To begin with, in any suitable manner, as by use of computer station 30, server 26 is instructed and enabled to gather, for storage within it (a residence site), each of the SNMP community strings associated with devices 14, 16, 18. for example, an information-system manager, utilizing station 30, may instruct server 26 to perform this operation. An alternative could include appropriate pre-configuring of server 26 to recognize the presence of entities, such as MFP devices 14, 16, 18, connected to data-communication structure 12, and to self-initiate an SNMP community string gathering procedure. And so, prior to the particular use-access operation which will now be described, server 26 possesses knowledge, at its site, of community strings 14a, 16a, 18a. It is via the communication which is represented by symbolic, dashed line 36 in FIGS. 1 and 3, that server 26 gains knowledge of SNMP community string 16a.

At any appropriate time, and as an illustration, on the first occasion of client application 20 seeking to make use of MFP device 16, one of the early steps that forms part of the methodology of the present invention is performed. This activity includes, effectively, a transmission to server 26 from client application 20 of authentication information (20a) and a return confirmation of the correctness thereof. These behaviors are represented by double-ended arrow 40 in FIG. 3.

Following authentication, client application 20 requests from server 26 the appropriate community string password for MFP device 16, and this request is represented in FIG. 3 by single-ended arrow 42. A single-ended arrow 44 in FIG. 3 represents a reply from server 26 which furnishes to client application 20 the requested SMNP community string. Thereafter, and as is illustrated by double-ended arrow 46 in FIG. 3, use communication between client application 20 and MFP device 16 is established.

This activity very clearly enhances the efficiency of “guarded” communication in network 10.

Turning attention now very specifically to FIG. 2 in the drawings, here there is shown generally at 48 a modified form of the system and methodology of this invention wherein like illustrated components, etc., are given the same reference numerals which appear for them in FIG. 1. What will here be noticed is that previously mentioned dashed lines 34, 36, 38 now possess arrow heads which point to server 26.

In this embodiment of the invention, server 26, while still acting as a residence site for SNMP community strings, does not directly function to inquire of the network entities what are their respective SNMP community strings. Rather, in this embodiment of the invention it is the network entity devices themselves, like MFP devices 14, 16, 18, which initiate a transmission communication whereby they inform server 26 of their respective community strings.

In all other respects, operation of system 48 is the same as that which has been described above for system 10.

Turning attention now to FIG. 4 in the drawings, indicated generally at 50 is another modified form of the system and methodology of the present invention. Here, too, network components pictured in FIG. 4 which are the same as certain network components illustrated in FIG. 1 are designated with the same respective reference numerals. Accordingly, what are shown in FIG. 4, communicatively connected to data-communication structure 12, are previously mentioned MFP devices 14, 16, and client applications 22, 24.

In this form of the system and method of the invention, client applications wishing to make use of network entities engage in an authenticated, direct inquiry of the particular sought network entity to gain directly a communication back from that entity informing the client application of the entity's community string. Curved arrows 52, 54 in FIG. 4 represent, respectively, (a) a client application's request for the SNMP community string of at least one of devices 14, 16, respectively, and (b) an appropriate return of information which contains the request SNMP community data string. In this form of the invention, the sought SNMP-guarded network entities act as their own respective residence sites for their SNMP strings.

Accordingly, the present invention offers a unique structure and methodology for managing the access which needs to be provided between a client application and some other network resource which is guarded by an SMNP community-string password. Client applications which are uniquely structured to make self-initiated, authenticatable requests of SNMP strings lead the process. The invention thus offers a communication opportunity and reality which enhances significantly the versatility and ease of establishment (in a network) of client-application-to-entity working relationships.

While a preferred embodiment and manner of practicing the invention and several modifications thereof, have been described herein, it will be appreciated that other variations and modifications may be made without departing from the spirit of the invention.

I claim:

1. In a computer network setting, an automated method whereby client applications are enabled to acquire network-entity Simple Network Management Protocol (SNMP) community-string (strings) passwords that enable client-application utilization of related, selected network entities, said method comprising
providing at least one site on the network which affords inquiring-access to the identifications of SNMP community strings that are specific to selected network entities, and
enabling a client application which intends to use one or more of those entities to make a client-application-authenticated, as-needed inquiry of the site so as to gain enabling knowledge of the desired entity's(ties') respective SNMP community string(s).

2. The method of claim 1 which further comprises, in conjunction with the action of a client-application's making a site inquiry, presentation by that application of self-authentication data, on the basis of which SNMP-string identification access to the site is determined.

3. The method of claim 1, wherein the site is common to all selected network entities.

4. The method of claim 1, wherein the site resides in a community-string database server which is communicatively coupled to the network.

5. The method of claim 4, wherein the site is common to all selected network entities.

6. The method of claim 1 which further comprises enabling a selected network entity automatically to communicate and report its respective, associated SNMP community string to the site.

7. The method of claim 4 which further comprises enabling a selected entity automatically to communicate and report its respective, associated SNMP community string to the site.

8. The method of claim 1, wherein the site effectively resides in a selected network entity which is directly addressable by an authenticating client application for the purpose of directly informing that application of its associated community string.

9. A computer network system for managing access to network entities which are guarded by Simple Network Management Protocol (SNMP) community-string passwords (strings) that are specific to different network entities, said system comprising
a network data-communication structure,
at least one SNMP community data-string-guarded network entity communicatively connected to said data-communication structure,
an SNMP community-string data-string residence site also communicatively connected to said data-communication structure, and possessing deliverable knowledge of the SNMP community string associated with said at least one network entity, and
a client application operatively and communicatively connectable to said data-communication structure, designed to make use of the at least one network entity, and furnished with a self-capability for successfully obtaining from said residence site employable knowledge of the at least one entity's SNMP community string, thereby to become postured to gain use-access to that network entity.

10. The system of claim 9, wherein said residence site is located in an SNMP community-string database server which is communicatively coupled to said data-communication structure.

11. The system of claim 9, wherein said client application, with respect to the mentioned self capability, is structured to initiate inquiry regarding the guarded at least one entity's SNMP community string through authenticating itself to said site.

12. For use in a network system wherein client applications are enabled to acquire Simple Network Management Protocol (SNMP) community-string password (strings) that enable client-application utilization of selected SNMP community-string-guarded network entities,
a client application constructed with authorization parameters associated with it which are employable by the client application to gain use-access to selected network resources that are protected by respective SNMP data-string passwords, with such use-access occurring through a process which involves requesting self-authorization-permitting, network-available knowledge of those passwords.
